(19) United States
(12) Patent Application Publication
(10) Pub. No.: US 2020/0044552 A1
(43) Pub. Date: Feb. 6, 2020

(54) SUPERCONDUCTOR MOTOR

(71) Applicant: Yen-Hwang CHIANG, Taipei City (TW)

(72) Inventor: Yen-Hwang CHIANG, Taipei City (TW)

(21) Appl. No.: 16/055,047

(22) Filed: Aug. 4, 2018

(51) Int. Cl. H02K 55/04

(52) U.S. Cl. CPC H02K 55/04

(57) ABSTRACT

A superconductor motor, which comprises: at least two superconductors, correspondingly arranged, capable of generating a static magnetic field, and served as a stator of a short-term permanent magnetic field; and a rotor, disposed between the at least two superconductors correspondingly arranged, wherein two ends of the rotor are respectively extended with an output shaft, and the axial periphery of the rotor is disposed with a plurality of anti-magnetic blades. Accordingly, advantage of effectively increasing efficiency, environmental friendly and lowering production cost are provided.

### BACKGROUND OF THE INVENTION

### 1. Field of the Invention

The present invention relates to a motor, especially to a superconductor motor utilizing at least two superconductors correspondingly arranged and served as a stator for generating a strong static magnetic field which is able to drive a plurality of anti-magnetic blades of a rotor.

### 2. Description of Related Art

After being exploited and consumed for a number of years, the fossil resource has reached a critical point of running out, and the global environment has also been destroyed and polluted; thus, people start to pay attention to the abnormal melting of the iceberg, the raising sea level, the weather changing and the haze pollution, various countries in this world have been searching for the alternative energy, for example an engine capable of driving a vehicle, a vessel or an airplane without using the fossil energy, a generator capable of generating electric power without using the radiating material, and a motor capable of being driven without using the conventional coil, iron block and battery or electric power; however, the battery still has the same shortage of polluting the environment, the motor using the coil and the iron block has shortages of heavy in weight and large in volume, and the motor, the engine and the power plant have shortages of generating loud noise, discharging a great amount of thermal energy, toxic gas, radiating substance, and totally unable to lower cost; at present, the people are more aware of the importance of loving the earth, environmental protection, saving energy and reducing carbon consumption, thus the practicability and the efficiency of the conventional motor, the engine and the power plant used for providing energy have been limited, so that the above-mentioned disadvantages and shortages shall be seriously concerned by the skilled people in the art.

### SUMMARY OF THE INVENTION

For solving the disadvantages and shortages existed in the prior art, one primary objective of the present invention is to provide a superconductor motor utilizing at least two superconductors correspondingly arranged and served as a stator for generating a strong static magnetic field which is able to drive a plurality of anti-magnetic blades of a rotor, so that the rotor and the anti-magnetic blades thereof can be rotated for generating energy just like being driven by winds, thereby overcoming the disadvantages and shortages existed in the prior art.

Another objective of the present invention is to provide a superconductor motor, which can provide a magnetic energy having advantages of zero pollution, low noise, low cost and capable of being unlimitedly supplied.

One another objective of the present invention is to provide a superconductor motor, which has advantages of effectively increasing efficiency, environmental friendly, lowering production cost.

The problems aimed to be solved by the present invention are that: after being exploited and consumed for a number of years, the fossil resource has reached a critical point of running out, and the global environment has also been destroyed and polluted; thus, people start to pay attention to the abnormal melting of the iceberg, the raising sea level, the weather changing and the haze pollution, various countries in this world have been searching for the alternative energy, for example an engine capable of driving a vehicle, a vessel or an airplane without using the fossil energy, a power plant without using the radiating material, and a motor capable of being driven without using the conventional coil, iron block and battery or electric power; however, the battery still has the same shortage of polluting the environment, the motor using the coil and the iron block has shortages of heavy in weight and large in volume, and the motor, the engine and the power plant have shortages of generating loud noise, discharging a great amount of thermal energy, toxic gas, radiating substance, and totally unable to lower cost; at present, the people are more aware of the importance of loving the earth, environmental protection, saving energy and reducing carbon consumption, thus the practicability and the efficiency of the conventional motor, the engine and the power plant used for providing energy have been limited

For solving the above-mentioned disadvantages and shortages, one technical solution provided by the present invention is to provide a superconductor motor, which comprises:

at least two superconductors, correspondingly arranged, capable of generating a static magnetic field, and served as a stator of a short-term permanent magnetic field; and

a rotor, disposed between the at least two superconductors correspondingly arranged, wherein two ends of the rotor are respectively extended with an output shaft, and the axial periphery of the rotor is disposed with a plurality of anti-magnetic blades.

Wherein, according to the present invention, the quantity of the superconductor is in a direct ratio with respect to the torque and the speed generated by the corresponding rotor and arranged with equal multiple intervals.

Wherein, according to the present invention, the axial peripheral shape of the rotor is formed as a plurality of convex pieces being arranged in a radial status.

Wherein, according to the present invention, the material adopted at the axial periphery of the rotor is a non-magnetic material.

Wherein, according to the present invention, the plural anti-magnetic blades arranged at the axial periphery of the rotor are made of bismuth, lead or copper.

Wherein, according to the present invention, the plural anti-magnetic blades of each of the convex pieces of the rotor are in parallel with each other and arranged with equal intervals with the same inclined angle.

Wherein, according to the present invention, the axial peripheral shape of the rotor is formed in an integral circular status, and the plural anti-magnetic blades are disposed at the periphery and spirally arranged with equal intervals thereby forming a half-moon-like arc-shaped status.

Wherein, according to the present invention, at least one of the output shafts of the rotor is connected to a variator used for controlling and supplying a force speed.

Wherein, according to the present invention, at least one of the output shafts of the rotor is disposed with a generator for generating electric power which is transferred to a transformer station via a bus.

Wherein, according to the present invention, at least one of the output shafts of the rotor is connected to a generator, the generator is connected to at least one speed controller, and the speed controller is connected to a motor.

Advantages achieved by the present invention while being compared with the prior art are as followings: the superconductor motor provided by the present invention is consisted of the superconductors correspondingly arranged and the rotor disposed between the superconductors, and the plural anti-magnetic blades are disposed at the axial periphery of the rotor, so that the magnetic energy having advantages of zero pollution, no thermal energy being discharged, no waste gas being discharged, no fossil fuel being used, low noise, low cost and capable of being unlimitedly supplied can be formed, and objectives of effectively increasing efficiency, environmental friendly, lowering production cost can be achieved.

### BRIEF DESCRIPTION OF THE DRAWINGS

FIG. 1 is a perspective exploded view according to the present invention;

FIG. 2 is a perspective view showing the assembly according to the present invention;

FIG. 3 is a cross sectional view showing the assembly according to the present invention;

FIG. 4 is a schematic view showing the magnetic action of the rotor and the static magnetic field of the superconductor according to the present invention;

FIG. 5 is a schematic view showing the structure of another rotor according to one embodiment of present invention;

FIG. 6 is a schematic view showing the present invention being provided with the variator capable of outputting force speed according to one embodiment of the present invention;

FIG. 7 is a schematic view showing the present invention being applied in a vessel with no fuel tank according to the one embodiment of present invention;

FIG. 8 is a schematic view showing the present invention being applied in a submarine with no fuel tank according to the one embodiment of present invention;

FIG. 9 is a schematic view showing the present invention being applied in a power plant according to the one embodiment of present invention; and

FIG. 10 is a schematic view showing the present invention being applied in an airplane with no fuel tank according to the one embodiment of present invention.

### DESCRIPTION OF CODES

100: Superconductor motor
1: Superconductor
11: Static magnetic field
2: Rotor
20: Convex piece
201: Anti-magnetic blade
21: Output shaft
F1, F2, F3: Force
3: Variator
4: Vessel
40: Submarine
41: Propeller
5: Generator
6: Transformer station
60: Bus
7: Airplane
71: Speed controller
72: Motor
73: Propeller

### DETAILED DESCRIPTION OF THE PREFERRED EMBODIMENT

Preferred embodiments of the present invention will be described with reference to the drawings. But what shall be addressed is that the drawings are served to provide a clear illustration, the scope and ratio thereof in actual practice can be varied.

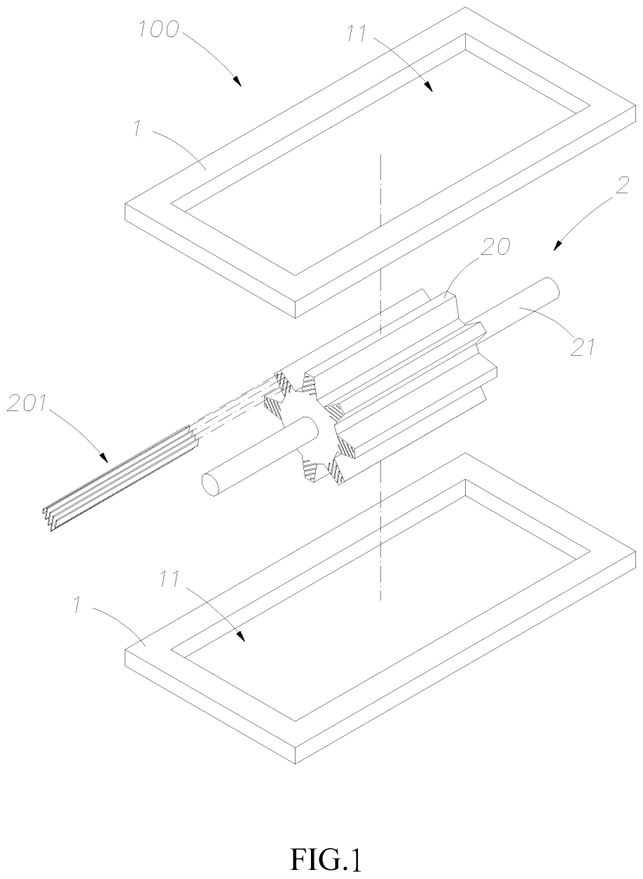

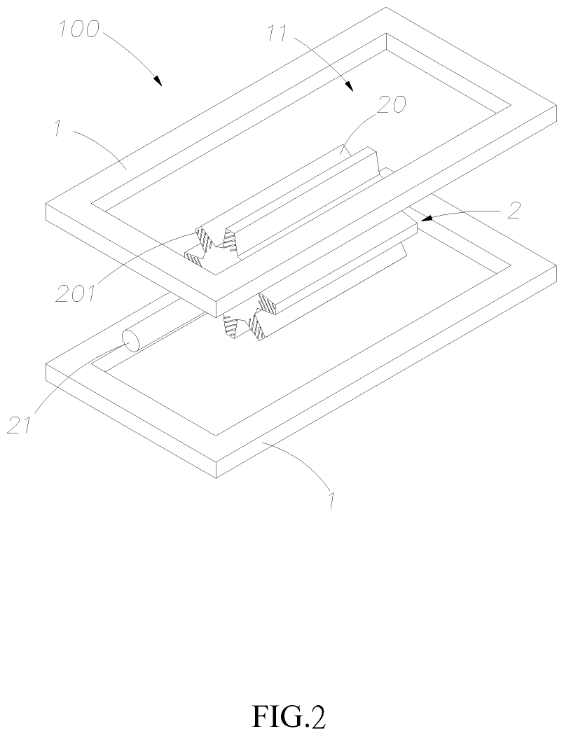

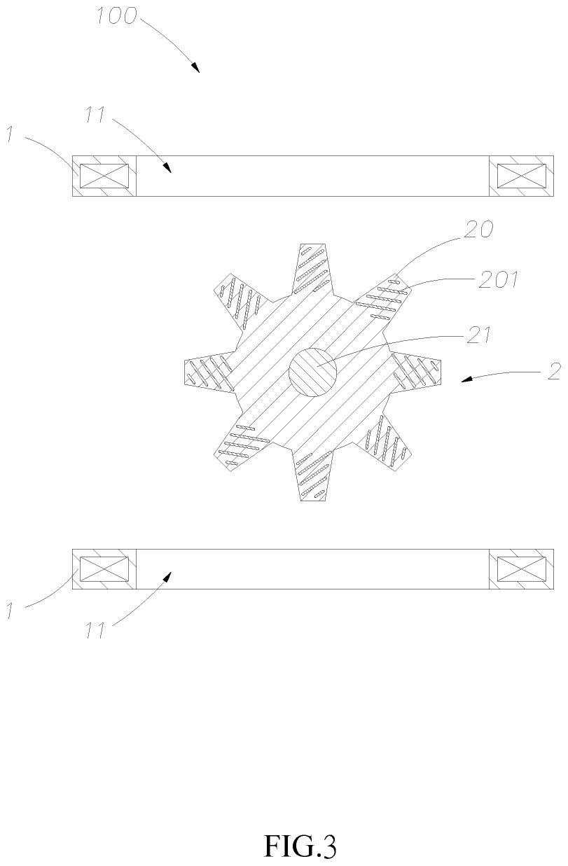

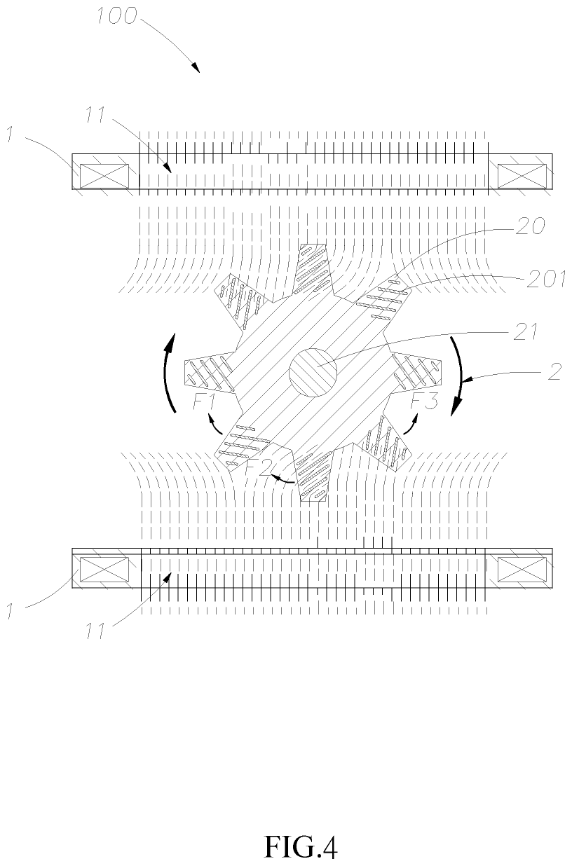

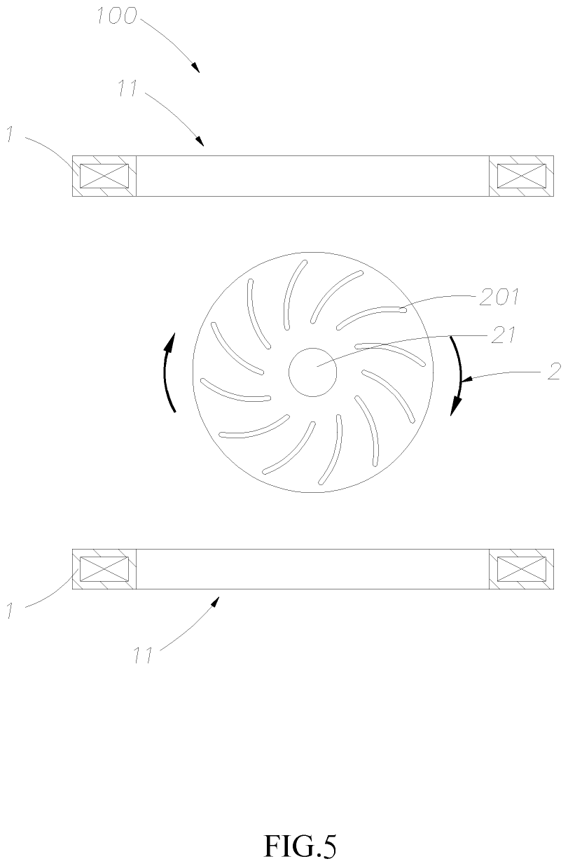

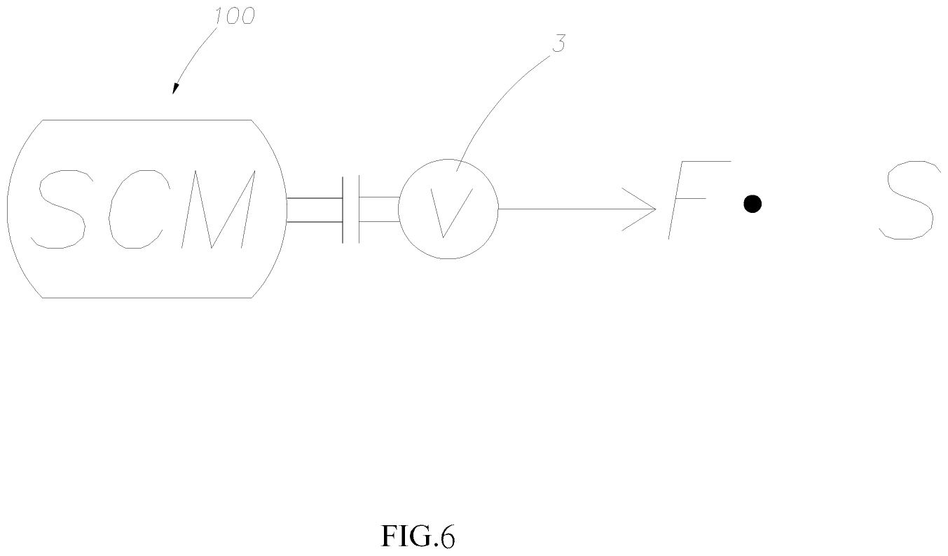

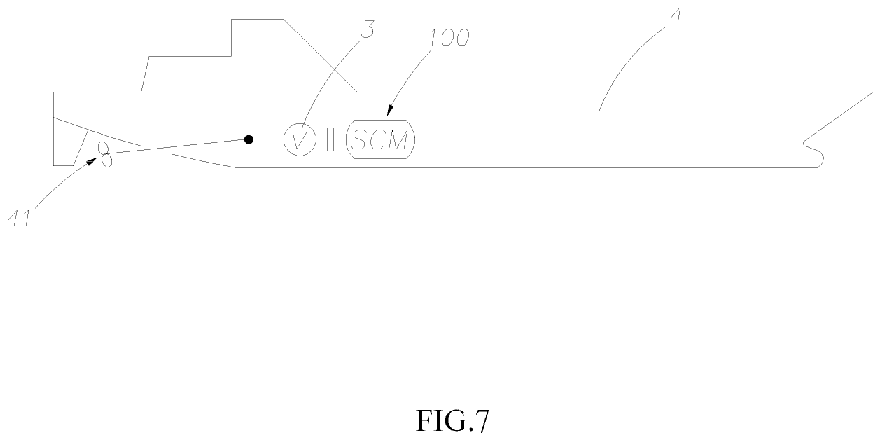

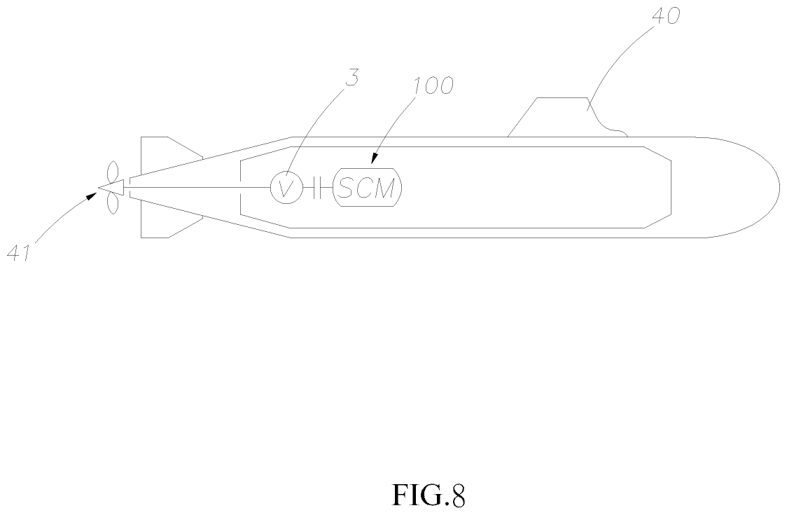

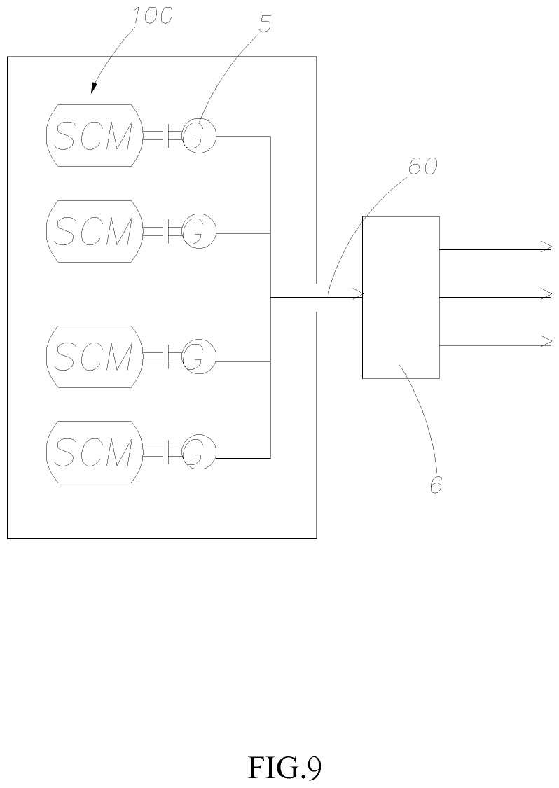

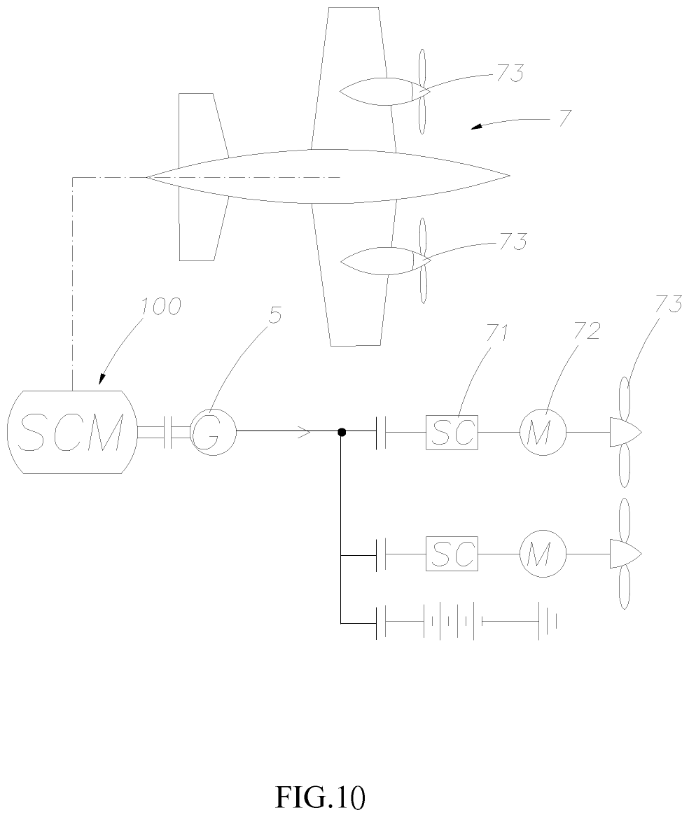

Please refer from FIG. 1 to FIG. 10, wherein FIG. 1 is a perspective exploded view according to the present invention; FIG. 2 is a perspective view showing the assembly according to the present invention; FIG. 3 is a cross sectional view showing the assembly according to the present invention; FIG. 4 is a schematic view showing the magnetic action of the rotor and the static magnetic field of the superconductor according to the present invention; FIG. 5 is a schematic view showing the structure of another rotor according to one embodiment of present invention; FIG. 6 is a schematic view showing the present invention being provided with the variator capable of outputting force speed according to one embodiment of the present invention; FIG. 7 is a schematic view showing the present invention being applied in a vessel with no fuel tank according to the one embodiment of present invention; FIG. 8 is a schematic view showing the present invention being applied in a submarine with no fuel tank according to the one embodiment of present invention; FIG. 9 is a schematic view showing the present invention being applied in a power plant according to the one embodiment of present invention; and FIG. 10 is a schematic view showing the present invention being applied in an airplane with no fuel tank according to the one embodiment of present invention. According to one preferred embodiment of the present invention, a superconductor motor (SCM) 100 comprising at least two superconductors 1 and a rotor 2 is disclosed.

The two superconductors 1 are correspondingly arranged for generating a static magnetic field 11 which can be served as a stator of a short-term permanent magnetic field; according to this embodiment, the superconductor 1 is a low-temperature superconductor, and the exterior thereof is enclosed by cooling liquid nitrogen or liquid helium, the quantity of the superconductor 1 is in a direct ratio with respect to the torque and the speed generated by the corresponding rotor 2 and arranged with equal multiple intervals.

The rotor 2 is disposed between the two superconductors 1 which are correspondingly arranged, two ends of the rotor 2 are respectively extended with an output shaft 21, the axial periphery of the rotor 2 is disposed with a plurality of anti-magnetic blades 201, and the axial peripheral shape of the rotor 2 is formed as a plurality of convex pieces 20 being arranged in a radial status (as shown from FIG. 1 to FIG. 4).

As shown in FIG. 4, the static magnetic field 11 generated by the superconductor 1 has different magnetic repulsion forces, the plural anti-magnetic blades 201 disposed on the central convex piece 20 and close to the superconductor 1 are provided with the largest magnetic repulsion force (coded as F1 in FIG. 4), the plural anti-magnetic blades 201 disposed on the convex piece 20 arranged at the left side of the central convex piece 20 are provided with the second largest magnetic repulsion force (coded as F2 in FIG. 4), and the plural anti-magnetic blades 201 disposed on the convex piece 20 arranged at the right side of the central convex piece 20 are provided with the smallest magnetic repulsion force (coded as F3 in FIG. 4), so that the F1+the F2>the F3, the rotor 2 is clockwise rotated for outputting work to the exterior, so that the static magnetic field 11 of the superconductor 1 served as the stator 1 is not affected thereby forming as a dynamic energy generating center or a dynamic energy source; the plural anti-magnetic blades 201 of each of the convex pieces 20 of the rotor 2 are in parallel with each other and arranged with equal intervals with the same inclined angle, but what shall be addressed is that the scope of the present invention is not limited to the above-mentioned arrangement; the axial peripheral shape of the rotor 2 cannot only be formed by the plural convex pieces 20, the axial peripheral shape of the rotor 2 can also be formed in an integral circular status, and the plural anti-magnetic blades 201 are disposed at the periphery and spirally arranged with equal intervals thereby forming a half-moon-like arc-shaped status (as shown in FIG. 5), and other geometric statuses are all within the scope of the present invention; the material adopted at the axial periphery of the rotor 2 is a non-magnetic material, such as plastic steel, zinc aluminum alloy or wood, but what shall be addressed is that the scope of the present invention is not limited to the above-mentioned materials; the plural anti-magnetic blades 201 arranged at the axial periphery of the rotor 2 are made of bismuth, lead or copper, but what shall be addressed is that the scope of the present invention is not limited to the above-mentioned materials.

According to the present invention, the superconductor 1 is capable of generating the strong static magnetic field 11 and served as the stator, because the static magnetic field 11 is able to last for three years, the superconductor 1 is enclosed by the sealed liquid helium or nitrogen and kept in the temperature of minus 120 degrees, the superconductor 1 can be prevented from generating heat while a current of 100,000 A passing through, the consumed energy is extremely little, and the resistance is close to zero, so that the strong short-term permanent static magnetic field 11 can be provided, and the static magnetic field 11 of the superconductor 1 can be at least remained at 98% in the three years, when the static magnetic field 11 is no longer provided, an electric power can be resupplied to the superconductor 1 for recovery.

According to superconductor motor (SCM) 100 provided by the present invention, at least one of the output shafts 21 of the rotor 2 is connected to a variator 3 used for controlling and supplying a force speed (F.S.), so that the force speed can be transferred or the supply of the force speed can be stopped through the variator 3 and the rotor 2 being engaged or separated (as shown in FIG. 6).

According to superconductor motor (SCM) 100 provided by the present invention, at least one of the output shafts 21 of the rotor 2 is connected to the variator 3, and the variator 3 is connected to a vessel 4 or a propeller 41 of a submarine 40 (as shown in FIG. 7 and FIG. 8).

According to the present invention, a plurality of the superconductor motors 100 can be provided, and at least one of the output shafts 21 of the rotor 2 is disposed with a generator 5 for generating electric power which is transferred to a transformer station 6 via a bus 60 for providing a function of HV transmission (as shown in FIG. 9).

According to superconductor motor (SCM) 100 provided by the present invention, at least one of the output shafts 21 of the rotor 2 is connected to the generator 5, the generator 5 is connected to at least one speed controller 71, and the speed controller 71 is connected to propellers 73 and motors 72 of an airplane 7 (as shown in FIG. 10).

Advantages achieved by the present invention while being compared with the conventional motor, the conventional engine and the conventional power plant are as followings: low noise (quiet in operation), no thermal energy being discharged, no carbon dioxide being discharged, no fossil fuel or radiating material, such as uranium, being used, so that objectives of low operation cost, light in weight, small in volume, high efficiency and low production cost can be achieved.

Based on what has been disclosed above, the superconductor motor (SCM) 100 provided by the present invention is consisted of the superconductors 1 correspondingly arranged and the rotor 2 disposed between the superconductors 1, and the plural anti-magnetic blades 201 are disposed at the axial periphery of the rotor 2, so that the magnetic energy having advantages of zero pollution, no thermal energy being discharged, no waste gas being discharged, no fossil fuel being used, low noise, low cost and capable of being unlimitedly supplied can be formed, and objectives of effectively increasing efficiency, environmental friendly, lowering production cost can be achieved; accordingly, the superconductor motor is novel and more practical is use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A superconductor motor, comprising:
at least two superconductors, correspondingly arranged, capable of generating a static magnetic field, and served as a stator of a short-term permanent magnetic field; and
a rotor, disposed between the at least two superconductors correspondingly arranged, wherein two ends of the rotor are respectively extended with an output shaft, and the axial periphery of the rotor is disposed with a plurality of anti-magnetic blades.

2. The superconductor motor as claimed in claim 1, wherein the quantity of the superconductor is in a direct ratio with respect to the torque and the speed generated by the corresponding rotor and arranged with equal multiple intervals.

3. The superconductor motor as claimed in claim 1, wherein the axial peripheral shape of the rotor is formed as a plurality of convex pieces being arranged in a radial status.

4. The superconductor motor as claimed in claim 1, wherein the material adopted at the axial periphery of the rotor is a non-magnetic material.

5. The superconductor motor as claimed in claim 1, wherein the plural anti-magnetic blades arranged at the axial periphery of the rotor are made of bismuth, lead or copper.

6. The superconductor motor as claimed in claim 3, wherein the plural anti-magnetic blades of each of the convex pieces of the rotor are in parallel with each other and arranged with equal intervals with the same inclined angle.

7. The superconductor motor as claimed in claim 1, wherein the axial peripheral shape of the rotor is formed in an integral circular status, and the plural anti-magnetic blades are disposed at the periphery and spirally arranged with equal intervals thereby forming a half-moon-like arc-shaped status.

8. The superconductor motor as claimed in claim 1, wherein at least one of the output shafts of the rotor is connected to a variator used for controlling and supplying a force speed.

9. The superconductor motor as claimed in claim 1, wherein at least one of the output shafts of the rotor is disposed with a generator for generating electric power which is transferred to a transformer station via a bus.

10. The superconductor motor as claimed in claim 1, wherein at least one of the output shafts of the rotor is connected to a generator, the generator is connected to at least one speed controller, and the speed controller is connected to a motor.
